(19) United States
(12) Patent Application Publication
(10) Pub. No.: US 2014/0135049 A1
(43) Pub. Date: May 15, 2014

(54) CONTROL STATION DEVICE, CENTRAL CONTROL STATION DEVICE, TERMINAL DEVICE, COMMUNICATION SYSTEM AND COMMUNICATION METHOD

(71) Applicants: Kozue Hirata, Osaka-shi (JP); Shinpei Toh, Osaka-shi (JP)

(72) Inventors: Kozue Hirata, Osaka-shi (JP); Shinpei Toh, Osaka-shi (JP)

(73) Assignee: SHARP KABUSHIKI KAISHA, Osaka-shi, Osaka (JP)

(21) Appl. No.: 14/126,740

(22) PCT Filed: May 21, 2012
(86) PCT No.: PCT/JP2012/062957

§ 371 Date: Dec. 16, 2013

(30) Foreign Application Priority Data
Jun. 17, 2011 (JP) 2011-134825

(51) Int. Cl. H04L 5/00; H04W 72/04

(52) U.S. Cl. CPC H04L 5/0032; H04L 5/0035; H04W 72/0426
USPC 455/501

(57) ABSTRACT

A control station device performs communications controlled by a central control station device. The control station device acquires information related to a control station device that becomes an interference source to a coverage area controlled by the control station device. The control station device notifies the central control station device of the information related to the control station device that becomes the interference source. The control station device acquires, from the central control station device, information related to a possibility of communications thereof. In this way, the control station device is provided that forms the communication system excellent in frequency usage efficiency based on interference source information and the like indicating an inter-cell interference status measured at each cell.

### TECHNICAL FIELD

The present invention relates to a communication system configured to cover a first coverage area and a second coverage area with communications in the first coverage area controlled by a central control station device, and with the second coverage area including a plurality of coverage areas, communications in the plurality of coverage areas respectively controlled by a plurality of control station devices, at least part of the second coverage area overlapping the first coverage area.

### BACKGROUND ART

If communications are performed using the same frequency band in a system including a plurality of cells different in zone diameter from each other, inter-cell interference becomes a major concern.

For example, a system may include a macro cell having a large zone diameter to cover a wide area with the macro cell including pico cells or femtocells, each having a smaller diameter, and a pico cell base station (PeNB: Pico eNodeB) may communicate with a terminal device (pico cell terminal device) accommodated by the pico cell. A signal transmitted from the pico cell base station to the pico cell terminal device serves as interference to a terminal device accommodated by another cell (a macro cell terminal device or a femtocell terminal device in this case).

A desired signal transmitted from within a single cell in this way may serve as interference with another cell. In particular, if there are many pico cells or femtocells in a macro cell, more interference sources are present, lowering communication quality of the entire system.

A method of distributing transmission power is disclosed as a method of reducing the effect of such inter-cell interference (Non Patent Literature 1). In the disclosed method, base stations share specific reception SINR (Signal to Interframe plus Noise power Ratio) requested by each terminal device, and the base stations distribute transmission power so that the condition of the specific reception SINR of each terminal device and a constraint condition of maximum transmission power of the base stations are satisfied.

In order to obtain a solution to power distribution that satisfies the conditions, iterative calculation of search for a large number of combinations is needed. As a reduction method of the amount of calculation, NPL 1 discloses a method of reducing the number of combinations by excluding terminal devices as a transmission target in the order of from low to high reception SINR.

### CITATION LIST

### Non Patent Literature

NPL 1: “Throughput Improvement by Power Reallocation in Multi-cell Coordinated Power Control”, The Institute of Electronics, Information and Communication Engineers, Technical Report RCS2008-162, December 2008

### SUMMARY OF INVENTION

### Technical Problem

Since the repetitive process is performed to determine a solution for the power distribution that satisfies the conditions in the transmission power distribution method described in NPL 1, the amount of calculation increases as the number of terminal devices and the number base stations increase. If a terminal device having a low reception SINR is excluded from the transmission target in order to reduce the amount calculation, only terminal devices having a high reception SINR are selected as a transmission target, leading to inequality in the transmission opportunity.

In view of the above problem, it is an object of the present invention to provide a control station device and the like that form a communication system excellent frequency usage efficiency in accordance with interference source information and the like indicating a status of inter-cell interference measured at each cell.

### Solution to Problem

In view of the above problem, the control station device of the present invention is a control station device in a communication system configured to cover a first coverage area and a second coverage area with communications in the first coverage area controlled by a central control station device, and with the second coverage area including a plurality of coverage areas, communications in the plurality of coverage areas respectively controlled by a plurality of control station devices, at least part of the second coverage area overlapping the first coverage area. As information that the central control station device uses to determine possibility of the communication in each of the first coverage area and the second coverage area, the control station device acquires information related to another control station device that becomes an interference source to the second coverage areas respectively controlled by the control station devices and notifies the central control station device of the acquired information.

In the control station device of the present invention, the information related to the other control station device becoming the interference source identifies the number of other control station devices becoming the interference sources or the other control station devices becoming the interference sources.

In control station device of the present invention, the control station device acquires, together with the information related to the other control station device becoming the interference source, information related to a receiving performance of a terminal device that serves as a communication partner of the control station device, and notifies the central control station device of the acquired information.

A central control station device of the present invention is a central control station device in a communication system configured to cover a first coverage area and a second coverage area with communications in the first coverage area controlled by the central control station device, and with the second coverage area including a plurality of coverage areas, communications in the plurality of coverage areas respectively controlled by a plurality of control station devices, at least part of the second coverage area overlapping the first coverage area. The central control station device acquires, from a control station device, information related to another control station device becoming an interference source to the second coverage areas respectively controlled by the control station devices, and determines possibility of communications in each of the first coverage area and the second coverage area in accordance with the acquired information, the number of receive antennas of a terminal device that serves as a communication partner of the central control station device and/or the control station device, and the number of streams in each cell.

In the central control station device of the present invention, the central control station device acquires information related to a receiving performance of a terminal device that serves as a communication partner of the control station device, and information related to a receiving performance of a terminal device that serves as a communication partner of the central control station device, and determines the number of streams in the plurality of second cells in accordance with the acquired information, and notifies the control station device of the pieces of information.

A terminal device of the present invention is a terminal device in a communication system configured to cover a first coverage area and a second coverage area with communications in the first coverage area controlled by a central control station device, and with the second coverage area including a plurality of coverage areas, communications in the plurality of coverage areas respectively controlled by a plurality of control station devices, at least part of the second coverage area overlapping the first coverage area. As information that the central control station device uses to determine possibility of communication in each of the first coverage area and the second coverage area, the terminal device notifies information of a receiving performance thereof to the central control station device via the control station device.

A communication system of the present invention is a communication system configured to cover a first coverage area and a second coverage area with communications in the first coverage area controlled by a central control station device, and with the second coverage area including a plurality of coverage areas, communications in the plurality of coverage areas respectively controlled by a plurality of control station devices, at least part of the second coverage area overlapping the first coverage area. The control station device acquires information related to another control station device that becomes an interference source to the second coverage areas respectively controlled by the control station devices, and notifies the central control station device of the acquired information. The central control station device determines possibility of communications in each of the first coverage area and the second coverage area in accordance with the information acquired from the control station device, the number of receive antennas of a terminal device that serves as a communication partner of the central control station device and/or the control station device, and the number of streams in each cell.

A communication method of the present invention is a communication method of a communication system configured to cover a first coverage area and a second coverage area with communications in the first coverage area controlled by a central control station device, and with the second coverage area including a plurality of coverage areas, communications in the plurality of coverage areas respectively controlled by a plurality of control station devices, at least part of the second coverage area overlapping the first coverage area. The control station device acquires information related to another control station device that becomes an interference source to the second coverage areas respectively controlled by the control station devices, and notifies the central control station device of the acquired information. The central control station device determines possibility of communications in each of the first coverage area and the second coverage area in accordance with the information acquired from the control station device, the number of receive antennas of a terminal device that serves as a communication partner of the central control station device and/or the control station device, and the number of streams in each cell.

### Advantageous Effects of Invention

The present invention with a simple configuration including transmit and receive filters reduces interference in a system where inter-cell interference is present. Furthermore, a system excellent in frequency usage efficiency is built because concurrent communications are enabled using the same resource in a large number of cells.

### BRIEF DESCRIPTION OF DRAWINGS

FIG. 1 illustrates an entire system of an embodiment.

FIG. 2 illustrates a functional configuration of a base station (macro cell base station) in the embodiment.

FIG. 3 illustrates interference with a cell in the embodiment.

FIG. 4 illustrates a process flow of the base station of the embodiment.

FIG. 5 illustrates an example of cooperative cell information of the embodiment.

FIG. 6 illustrates a functional configuration of a terminal device (pico cell terminal device) of the embodiment.

FIG. 7 illustrates an application example of the embodiment.

FIG. 8 illustrates an application example of the embodiment.

FIG. 9 illustrates an application example of the embodiment.

### DESCRIPTION OF EMBODIMENTS

The best mode for carrying out the present invention is described with reference to the drawings.

### 1. First Embodiment

### 1.1 System Configuration

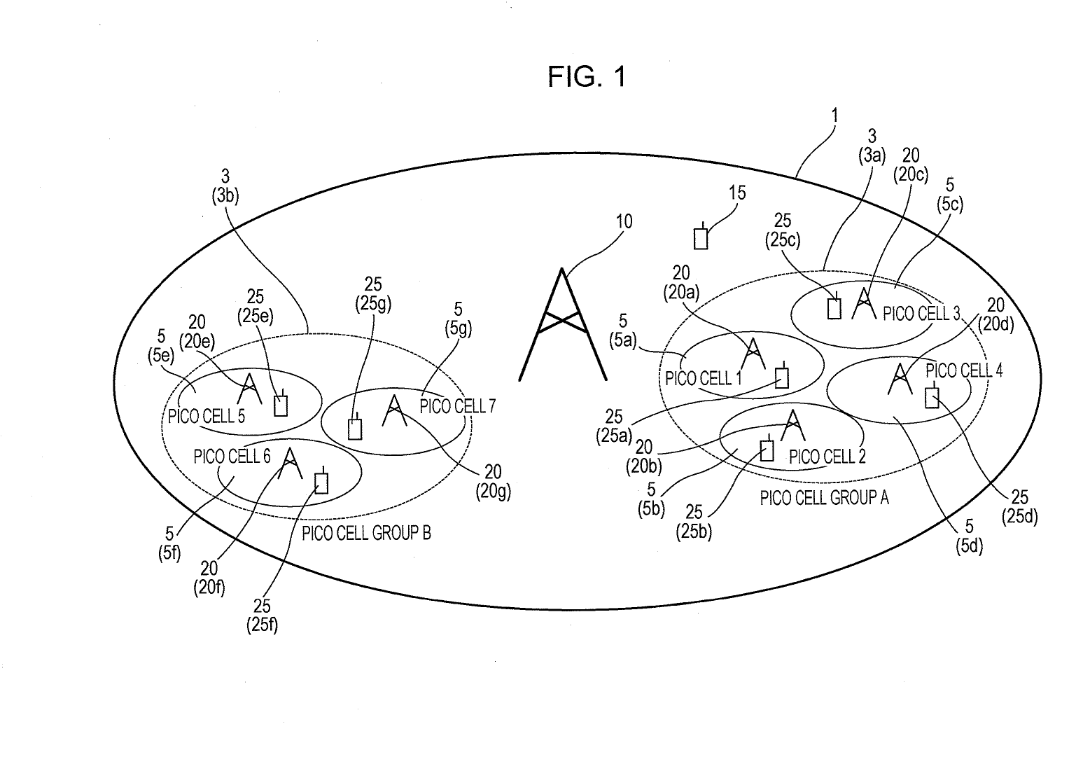

FIG. 1 illustrates a configuration example of a communication system of an embodiment. As illustrated in FIG. 1, a pico cell group 3 is present to cover a narrow area in a macro cell having a wide coverage area. A present embodiment includes two pico cell groups, pico cell group A (3a in FIG. 1), and pico cell group B (3b in FIG. 1).

The pico cell group includes a plurality of pico cells 5 that mutually interfere with each other. The pico cell group A (3a) includes four pico cells (pico cell 1 (5a) through pico cell 4 (5d)), and the pico cell group B (3b) includes three pico cells (pico cell 5 (5e) through pico cell 7 (5g)).

Each cell (macro cell 1, and pico cell 1 (5a) through pico cell 7 (5g)) includes a base station and a single terminal device, and the base station transmits a designed signal of one stream to the terminal device. Note that the macro cell 1 includes a macro cell base station 10, and a macro cell terminal device 15 connected to the macro cell base station 10, and the pico cell 5 includes a pico cell base station 20 and a pico cell terminal device 25 connected to the pico cell base station 20. In the present embodiment, the number of transmit antennas in each base station and the number of receive antennas in each terminal device is four. In the communication system, the pico cell base station functions as a control station device that controls communications in the pico cell thereof, and the macro cell base station functions as a central control station device that controls communications and the control station device within the macro cell thereof.

The convention used for the pico cell 5, and the pico cell base station 20 and the pico cell terminal device 25 included in the pico cell 5 in the description is described below. More specifically, referring to FIG. 1, the pico cell 5a is referred to a pico cell 1, and the pico cell base station included in the pico cell is referred to as a pico cell base station 1 (20a in FIG. 1), and the pico cell terminal device included in the pico cell 1 is referred to as a pico cell terminal device 1 (25a in FIG. 1). Similarly, the pico cell base station included in the pico cell 2 (5b) is referred to as a pico cell base station 2 (20b), and the pico cell terminal device included in the pico cell 2 is referred to as a pico cell terminal device 2 (25b), and so on.

The macro cell terminal device 15 connected to the macro cell base station 10 is located close to the pico cell group A (3a), and the macro cell 1 and the pico cell group A (3a) interfere with each other.

On the other hand, as for the pico cell group B (3b), the transmission power of the macro cell base station 10 is higher than the transmission power of the pico cell base station 20 and the macro cell 1 and the pico cell group B (3b) are far apart from each other. The macro cell 1 interferes with the pico cell group B (3b), but the pico cell group B (3b) does not interfere with the macro cell 1.

The terminal device in the pico cell 1 (5a) receives from a desired signal transmitted from the pico cell base station 1 (20a) included in the macro cell 1 (5a) and addressed to the pico cell terminal device 1 (25a) included in the pico cell 1 (5a) and, an interfering signals, desired signals transmitted by the macro cell base station 10 and pico cell base stations in pico cells 2 through 4 and respectively addressed to pico cell terminal devices thereof.

The same is true of pico cells 2 (5b) through pico cell 4 (5d), and each terminal device in the pico cell group A (3a) receives the desired signal of one stream and the four interfering signals. The number of receive antennas of each terminal device is four, and the number of streams of the desired signal is one. The degree of freedom is thus three, in other words, the number of interfering signals removable is three. Therefore, the terminal device in the pico cell group A (3a) lacks the degree of freedom, and if an incoming signal is multiplied by a linear receive filter, a desired signal cannot be extracted.

The pico cell terminal device 5 (25e) in the pico cell 5 (5e) receives a desired signal from the pico cell 5 (20e) and as interfering signals, desired signals transmitted by the macro cell base station 10, the pico cell base station 6 (20f) and the pico cell base station 7 (20g) and respectively addressed to pico cell terminal devices thereof. Each terminal device in the pico cell group B (3b) receives the desired signal of one stream and the three interfering signals. The terminal device in the pico cell group B (3b) has sufficient degree of freedom. The desired signal can thus be extracted by multiplying the received signal by an appropriate linear receive filter.

The macro cell terminal device 15 receives a desired signal from the macro cell base station 10 and interference from the pico cell group A (3a). Therefore, the macro cell terminal device 15 receives the desired signal of one stream, and four interfering signals. In the same manner as with the pico cell group A (3a), the macro cell terminal device 15 lacks the degree of freedom.

The definition of a channel between the base station and the terminal device is described herein. Let H_{MM} describe a channel between the macro cell base station 10 and the macro cell terminal device 15, H_{MPi} represent a channel between the macro cell base station 10 and a pico cell terminal device j (j=1, . . . , 7), H_{PiM} represent a channel between a pico cell base station i (i=1, . . . , 7) and a macro cell terminal device, and H_{PiPj} represent a channel between the pico cell base station i (i=1, . . . , 7) and the pico terminal device j (j=1, . . . , 7).

The macro cell and the pico cell are assumed as an example. Any cell combination may be acceptable as long as a desired signal at one cell may be interference to another cell. A cell or a zone including Remote Radio Equipments (RRE), a femtocell, a hotspot, and a relay station may be handled as an example. The macro cell base station (central control station) and each pico cell base station are connected via a wired network, and base stations can share information.

### 1.2 Configuration of Macro Cell Base Station

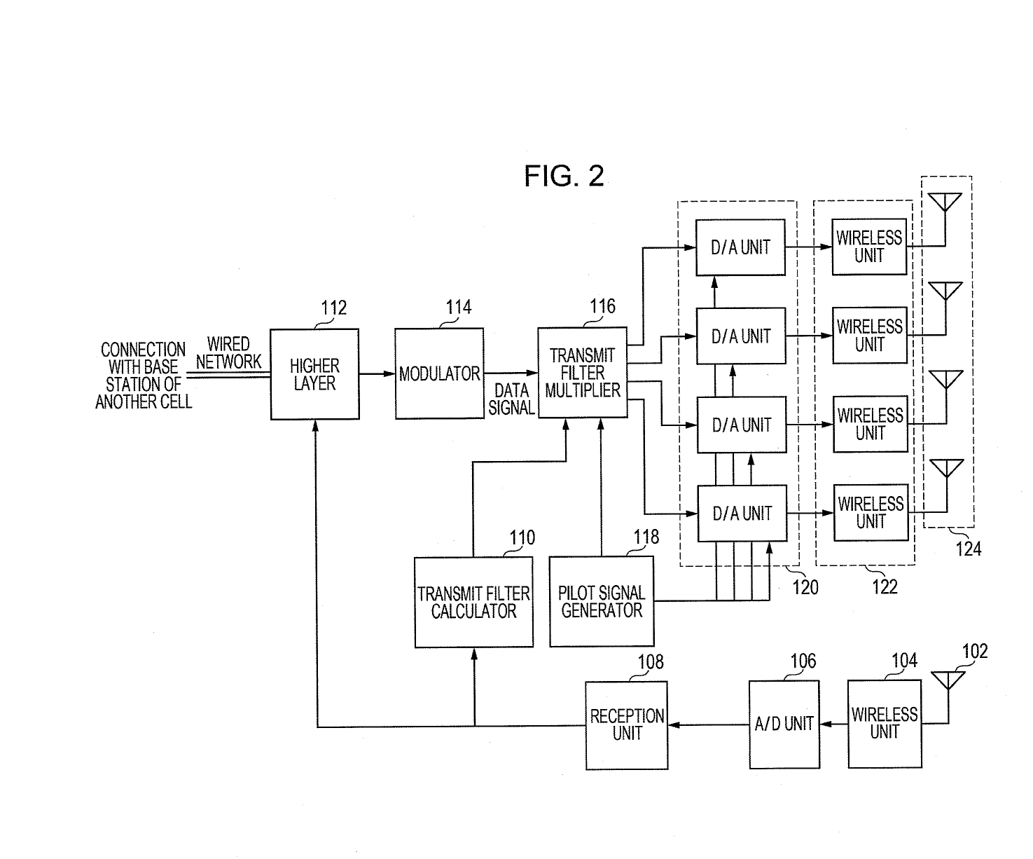

FIG. 2 illustrates a functional configuration of the macro cell base station 10 of the embodiment. The macro cell base station 10 of FIG. 2 groups mutually interfering cells in accordance with information related to interference notified by the pico cell base station 20 and the macro cell terminal device 15, and then determines a combination of cells that performs a transmission operation using the same resources so that the degree of freedom of each terminal device is satisfied in each group.

The macro cell base station 10 calculates a transmit filter W_{TX(M)} for use in a data transmission addressed to the macro cell terminal device 15, and performs a precoding operation. The precoding operation herein refers to a process to multiply the calculated transmit filter by a transmission signal.

Since the channel H_{MM} between the macro cell base station 10 and the macro cell terminal device 15 is needed to calculate the transmit filter, the macro cell terminal device 15 estimates the channel H_{MM} from a pilot signal in advance, and notifies the macro cell base station 10 of the channel H_{MM}.

The macro cell base station 10 also manages information related to an interference source in all the cells (interference source information). In one method of collecting such information, the terminal device in each cell notifies the base station in the pico cell connected thereto of the information, and the pico cell base station 20 notifies the macro cell base station 10 of the interference source information via a wired network.

A receive antennal 102 of the macro cell base station 10 receives a signal transmitted from the macro cell terminal device 15 and then outputs the signal to the wireless unit 104. The wireless unit 104 down-converts the received signal input from the receive antenna 102 to generate a baseband signal and outputs the baseband signal to an A/D (Analog to Digital) unit 106.

The A/D unit 106 converts the input analog signal into a digital signal, and outputs the digital signal to the reception unit 108. The reception unit 108 extracts from the input digital signal a channel H_{M}, interference source information acquired by the macro cell terminal device, and receive antenna count information N_{RX(M)} of the macro cell terminal device and outputs the channel H_{M} to the transmit filter calculator 110, and the interference source information and the receive antenna count information N_{RX(M)} to a higher layer 112. The receive antenna count information N_{RX(M)} here is four.

The higher layer 112 is connected to a plurality of pico cell base stations 5 via a wired network. The higher layer 112 is notified by the pico cell base stations 5 of the interference source information of each pico cell, receive antenna count information N_{RX(Pi)} of each pico cell terminal device, and stream count information R_{Pi} of each pico cell. The higher layer 112 is also notified by the reception unit 108 of the interference source information of the macro cell, and the receive antenna count information N_{RX(M)} of the macro cell terminal device.

The receive antenna count information N_{RX(Pi)} of each pico cell terminal device is N_{RX(P1)}=N_{RX(P2)}=N_{RX(P3)}=N_{RX(P4)}=N_{RX(P5)}=N_{RX(P6)}=N_{RX(P7)}=4. The stream count information R_{Pi} represents the number of streams the base station at each pico cell transmits to the terminal device, and R_{P1}=R_{P2}=R_{P3}=R_{P4}=R_{P5}=R_{P6}=R_{P7}=1, and the stream count R_{M} of the macro cell=1.

The stream count information may be determined on each cell (the macro cell and each of the pico cells illustrated in FIG. 1). The stream count information may be determined by the base station in each cell, or may be acquired from the terminal device in each cell (the pico cell terminal device 25). It is sufficient if the interference source information identifies any cell that serves as an interference source to a given cell. One example of the interference source information is an ID of a cell that is interfered with.

It is sufficient if the interference source information is determined by the base station or the terminal device on each cell. The terminal device in each cell may measure power of interference or the like coming in from a nearby cell, generate the interference source information based on the measurement results, and notify the base station of the interference source information. The same process may be performed by the base station to generate the interference source information.

In the present embodiment, the pico cell 1 (5a) through pico cell 4 (5d) and the macro cell interfere with each other. The interference source information of the pico cell 1 (5a) through pico cell 4 (5d) is a total of four cell IDs including three cell IDs of three cells excluding a host cell within the pico cell group A (3a), and the cell ID of the macro cell.

Similarly, in the pico cell 5 (5e) through pico cell 7 (5g), the interference source information of the pico cell 5 (5e) through pico cell 7 (5g) is cell IDs including two cell IDs of two cells excluding a host cell within the pico cell group B (3b), and the cell ID of the macro cell. On the other hand, since the macro cell receives interference from the pico cell 1 (5a) through pico cell 4 (5d), the interference source information of the macro cell is four cell IDs of the pico cell 1 (5a) through pico cell 4 (5d).

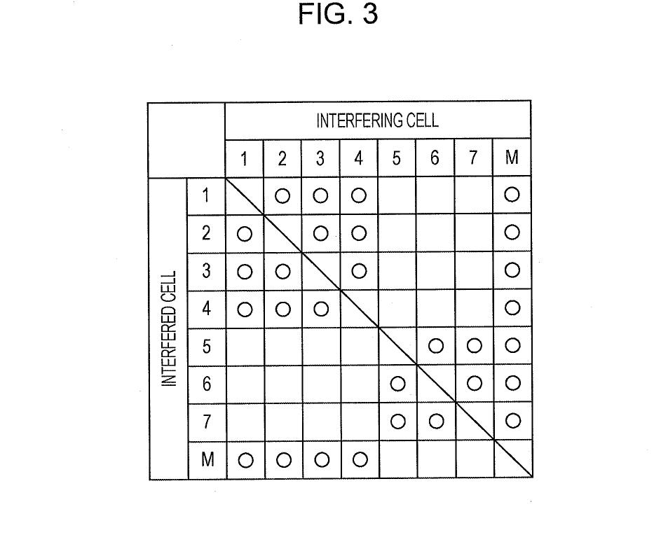

FIG. 3 lists the interference source information notified by each pico cell and the interference source information of the macro cell. FIG. 3 lists whether each cell is interfered with another cell, more specifically, a blank circle indicates that each cell is interfered with another cell, and a blank grid cell indicates that the cell is not interfered with another cell. For example, a row of cell 1 of FIG. 3 has blank circles in grid cells of interfering stations 2, 3, 4, and M. This means that the pico cell 1 (5a) receives interference from the pico cell 2 (5b), the pico cell 3 (5c), the pico cell 4 (5d), and the macro cell 1.

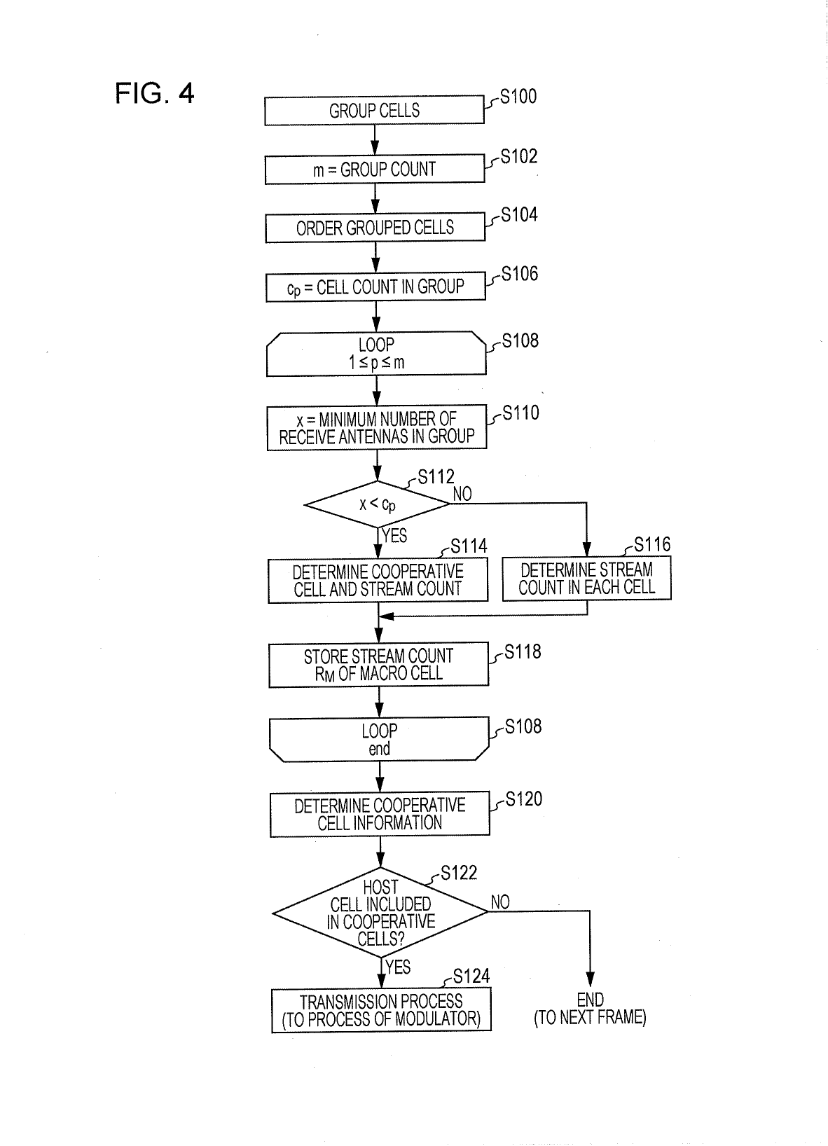

FIG. 4 herein illustrates a process flow of the higher layer 112. In step S100 of FIG. 4, interfering cells are grouped according to the interference source information. According to the interference source information, the pico cells mutually interfere with each other in each pico cell group, and furthermore, the macro cell interferes with the two pico cell groups. The grouping is performed to form two groups, one group including the pico cell group A (the pico cell 1 (5a) through the pico cell 4 (5d)) and the macro cell and the other group including the pico cell group B (the pico cell 5 (5e) through the pico cell 7 (5g)) and the macro cell. In succession, let m represent the number of groups, and m=2 (step S102).

In step S104, the grouped cells are ordered in sequence. In the following process, the number of cells that concurrently perform a transmission process in each group is adjusted so that the number of interference occurrences in each group is adjusted, and so that the degree of freedom in the terminal is satisfied.

Since the number of cells that can concurrently perform the transmission operation in each group depends on the number of receive antennas in each terminal device and the total number of cells in each group, the process needs to be performed starting with a group subject to severe constraints. In step S104 therefore, the cells grouped to determine the order of operations in step S108 and subsequent steps are ordered in sequence.

More specifically, the ordering is performed with priority placed on a group including a terminal device having a smaller number of receive antennas. If the numbers of receive antennas are equal, the ordering is performed with priority placed on a group including a larger number of cells. In accordance with the present embodiment, all the terminal devices each have the number of receive antennas of four, and the ordering is thus performed in view of the number of cells in each group, in other words, performed with priority placed on a group including a larger number of cells. As a result, the pico cell 1 (5a) through the pico cell 4 (5d)) and the macro cell 1 are set to be a group 1, and the pico cell 5 (5e) through the pico cell 7 (5g)) and the macro cell 1 are set to be a group 2.

In succession, in step S106, a cell count of each group is set to be cₚ (p=1, . . . , m). In the present embodiment, c₁=5, and c₂=4.

Two steps S108 represent a start point and an end point of a repetitive process, and the process enclosed by steps S108 is repeated while condition 1≦p≦group count m remains established. In the present embodiment, the process is performed with p=1 and 2. First, the process is performed with p=1, namely, on the group 1.

In step S110, a minimum number of receive antennas in the group is substituted for x. The receive antenna count of the group 1 is N_{RX(P1)}=N_{RX(P2)}=N_{RX(P3)}=N_{RX(P4)}=N_{RX(M)}=4, and thus x=4.

If it is determined in step S112 that a minimum receive antenna count x is smaller than the cell count cₚ in the group, processing proceeds to “YES” branch. In such a case, interference signals in excess of the degree of freedom of the terminal having the minimum receive antenna count arrive if all cells in the group respectively transmit one stream. This is interpreted to mean that the multiplication of the linear receive filter at the terminal device is unable to remove the interference. It is thus determined that the degree of freedom in at least one terminal device in the group is insufficient.

In a process subsequent to the YES branch, the cells (cooperative cells) to concurrently perform the transmission operation are adjusted to reduce the number of interference signals in the group and then the number of streams transmitted by each cell is determined.

On the other hand, the condition in step S112 is not satisfied, processing proceeds to “NO” branch. In such a case, it is determined that the degree of freedom of each of the terminal devices in the group is sufficient. All the cells in the group are set to be cooperative cells, and each cell determines the number of streams to be transmitted. Since x=4 and c₁=5 with p=1, processing proceeds to “YES” branch.

In step S114, the number of streams in each of the cooperative cells and each cell is determined so that the condition of the cooperative cell count≦the minimum receive antenna count x in the group holds. If the stream count R_{M} of the cell common to the group in the past (the macro cell in the present embodiment) is determined and still stored, the stream count in the macro cell as the common cell remains unchanged from the already determined stream count.

The process with p=1 is a first process to be performed for the first time, and R_{M} is thus not stored. The stream count of the macro cell is thus determined in the current process. The cell combination that causes the cooperative cell count to be four (the minimum receive antenna count x) out of the five cells in the group.

For example, the cooperative cells are determined as the four cells including the pico cell 2 (5b), the pico cell 3 (5c), the pico cell 4 (5d), and the macro cell 1, and the stream counts of the cooperative cells are respectively set to be one stream (R_{M}=R_{P2}=R_{P3}=R_{P4}=1, and R_{P1}=0). In this case, the number of interference signals and desired signals is R_{M}+R_{P1}+R_{P2}+R_{P3}+R_{P4}=1+0+1+1+1=4. The desired signal can be received with the minimum receive antenna count x.

In this way, in the present embodiment, if the number of interference signals is too many to be removed due to the constraint of the minimum receive antenna count x in the group, the cooperative cells are determined in the group so that transmission from some cell is stopped.

The cell combination with one of the five cells in the group suspended becomes the cooperative cells, for example, [the pico cell 1 (5a), the pico cell 3 (5c), the pico cell 4 (5d), and the macro cell 1], [the pico cell 1 (5a), the pico cell 2 (5b), the pico cell 4 (5d), and the macro cell 1], [the pico cell 1 (5a), the pico cell 2 (5b), the pico cell 3 (5c), and the macro cell 1], or [the pico cell 1 (5a), the pico cell 2 (5b), the pico cell 3 (5c), and, the pico cell 4 (5d)]. In the present embodiment, the cooperative cells are alternated at different timings (frame).

In step S118, R_{M} is stored if the stream count R_{M} of the past macro cell is not stored. Therefore, if p=1, R_{M}=1.

Processing proceeds to step S108, and then returns to the start point of the loop of step S108. In step S108, p=2, and the process is performed on the group 2. In step S110, x represents a minimum receive antenna count in the group 2. Since N_{RX(P5)}=N_{RX(P6)}=N_{RX(P7)}=4, thus x=4.

Since x=4 and c₂=4 in step S112, processing proceeds to “NO” branch. In other words, it is determined that the degree of freedom of each of the terminal devices in the group is sufficient, and all the cells in the group become cooperative cells.

In step S116, the stream count in each cell is determined so that the condition of the sum of streams transmitted by the cells≦the minimum receive antenna count x of the group holds with the cooperative cells unchanged. If the stream count R_{M} of the macro cell is stored in the past process, the stream count of another cell is adjusted without changing the stream count of the macro cell.

R_{M} is stored in step S118 if the stream count R_{M} of the macro cell in the past is not stored. Since with p=1, R_{M}=1 is already stored, no operation is performed with p=2.

In the present embodiment, R_{M}=R_{P5}=R_{P6}=R_{P7}=1, and the cooperative cell count is 4, for example. If the cooperative cell count is 3, the cooperative cell count is smaller than the minimum receive antenna count x=4. The stream count of some of the cells other than the macro cell may be increased within the range of the degree of freedom of the terminal devices as follows: R_{M}=R_{P5}=R_{P6}=1 and R_{P7}=2. In step S108, the repetitive process ends with p=m=2.

Through the above process, the cooperative cells are determined so that the degree of freedom of each of the terminals is satisfied. The process is performed at different timing (frame). In the suspension cell determination in S114 in the present embodiment, the cells to be suspended are alternately switched on a per frame basis.

For example, the combinations of the cells that concurrently transmit the streams are determined at a first frame with a combination of the pico cell 2 (5b), the pico cell 3 (5c), the pico cell 4 (5d), and the macro cell 1, at a second frame with a combination of the pico cell 1 (5a), the pico cell 3 (5c), the pico cell 4 (5d), and the macro cell 1, and at a third frame with a combination of the pico cell 1 (5a), the pico cell 2 (5b), the pico cell 4 (5d), and the macro cell 1.

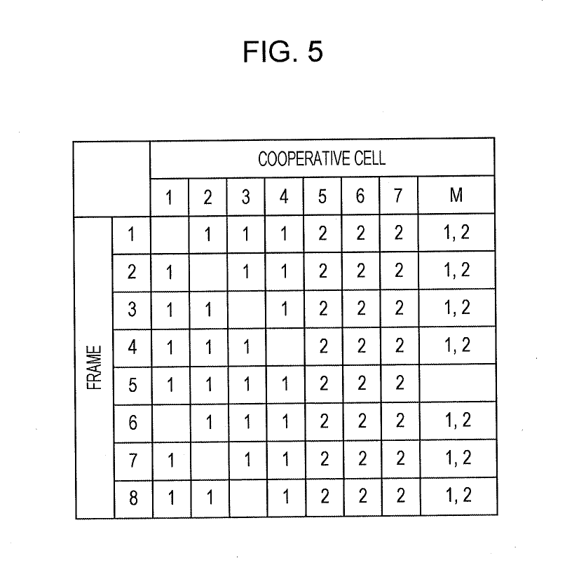

FIG. 5 illustrates cooperative cell information thus determined in the present embodiment. FIG. 5 illustrates the cells that concurrently transmits streams at each frame, for example, at a frame 1, the four cells including the pico cell 2 (5b), the pico cell 3 (5c), the pico cell 4 (5d), and the macro cell 1 (in the group 1) respectively concurrently transmit the streams, and the four cells including the pico cell 5 (5e) through the pico cell 7 (5g), and the macro cell 1 (in the group 2) respectively concurrently transmit the streams.

The cooperative cell information herein indicates cell IDs, and simply identifies which cell to transmit streams on a per frame basis. According to the cooperative cell information, each cell itself determines whether to transmit a stream. The cooperative cell information is not limited to these pieces of information.

In step S120, the cooperative cell determined on a per frame basis as illustrated in FIG. 5 serves as the cooperative cell information. As described above, the number of cells that concurrently transmit streams is adjusted so that the number of interference signals does not exceed the degree of freedom of the receive antennas. The inter-cell interference caused by the reception process of each terminal device is thus removed. The higher layer notifies the cell combination determined on a per frame basis as the cooperative cell information to each pico cell base station via the wired network.

It is determined in step S122 in accordance with determined cooperative cell information whether a macro cell is included in the cooperative cells. If the macro cell is included in the cooperative cells (YES branch from step S122), a modulator 114 performs a subsequent transmission operation (step S124). If the macro cell is not included in the cooperative cells (NO branch from S122), the modulator 114 does not a transmission operation at the frame this time.

Returning to the discussion of FIG. 2, the modulator 114 modulates a transmission information symbol d_{M} into a transmission data signal s_{M} in accordance with a transmission scheme, such as QPSK (Quadrature Phase Shift Keying) or 16QAM (Quadrature Amplitude Modulation) and outputs the transmission data signal s_{M} to a transmit filter multiplier.

The transmit filter calculator 110 calculates a transmit filter W_{TX(M)} from the channel H_{M} input from the reception unit 108. The transmit filter W_{TX(M)} herein is a transmit filter with which the macro cell base station performs precoding. It is sufficient if the stream count information R_{M} is transmitted from the macro cell base station to the macro cell terminal device, and any type of filter may be used for the transmit filter W_{TX(M)}.

As one example, a transmit filter of Expression (1) is used. As expressed by Expression (1), the transmit filter calculator 110 performs singular value decomposition (SVD) on the channel H_{MM}, and sets a vector of 4-row and 1-column as a left-most column extracted from the right singular vector V_{M} of 4-row and 4-column to be the transmit filter W_{TX(M)}

[Math. 1]

H_{MM}=U_{M}D_{M}V_{M}^{H} (1)

In accordance with Expression (2), a transmit filter multiplier 116 multiplies the transmission data signal s_{M} by the transmit filter W_{TX(M)} to generate a transmission signal x_{M}.

[Math. 2]

x_{M}=W_{TX(M)}s_{M} (2)

There is typically a constraint on the transmission power of the macro cell base station, such as maximum transmission power per transmit antenna. There are times when a signal obtained by multiplying x_{M} of Expression (2) by any coefficient may be set to be a transmission signal in order to set the power of the transmission signal x_{M} subsequent to the precoding process to be equal to or below a limit value. For simplicity of explanation herein, the coefficient to limit the transmission power is not considered.

A pilot signal generator 118 generates a known pilot signal, and outputs the pilot signal to the transmit filter multiplier 116. The transmit filter multiplier 116 multiplies the input known pilot signal by the transmit filter W_{TX(M)}, and then outputs the product together with the transmission signal x_{M} to a D/A (Digital to Analog) unit 120.

The D/A unit 120 converts digital-to-analog converts a multiplexed signal from the digital signal to the analog signal, a wireless unit 122 up-converts an input analog signal to a radio frequency, and then transmits the resulting signal to the macro cell terminal device 15 via a transmit antenna 124.

Also, the macro cell base station 10 of the present embodiment transmits a pilot signal that causes the macro cell terminal device 15 to estimate the channel H_{MM}, an equivalent channel estimating pilot signal to demodulate a data signal, a data signal, and cooperative cell information stored by the higher layer.

The pilot signal for the equivalent channel estimation is a signal that is obtained by multiplying the known pilot signal by the transmit filter W_{TX(M)}. Upon receiving the pilot signal for the equivalent channel estimation, each terminal device estimates not only an equivalent channel to the base station of the cell of the terminal device (such as H_{MM}W_{TX(M)}) but also an equivalent channel to a base station in another cell (such as H_{MPi}W_{TX(M)}). The terminal device can thus generate the receive filter on these estimated equivalent channels. In order to appropriately calculate the receive filter, the macro cell base station may transmit to the terminal device the cooperative cell information together with the pilot signal for the equivalent channel estimation and the data signal.

The pilot signal to estimate the channel H_{MM} does not necessarily have to be multiplexed with the data signal or the like, and may be transmitted at different timings (frames). The pilot signals from the transmit antennas are transmitted using time resources that cross orthogonally so that the pilot signals do not interfere with each other at the receiver side. In a multi-carrier transmission, system, the pilot signals may be transmitted using different subcarriers form the transmit antennas. Alternatively, each pilot signal may be multiplied by orthogonal code to generate an orthogonal pilot signal, and the orthogonal pilot signal is then transmitted.

### 1.3 Configuration of Pico Cell Base Station

In succession, the configuration of the pico cell base station 20 is described below. The pico cell base station 20 is identical in configuration to the macro cell base station 10, and is illustrated in FIG. 2. However, the process of the higher layer is different from that of the macro cell base station 10.

The macro cell base station 10 determines the cooperative cells in accordance with the interference source information notified by each cell, the receive antenna count of the terminal device, and the stream count information so that the degree of freedom of the concurrently connected terminal devices in the cell is satisfied. The pico cell base station 20 does not perform this process.

The receive antenna 102 receives a signal transmitted from the pico cell terminal device i of the host cell (i=1, . . . , 7), and outputs the signal to the wireless unit 104. The wireless unit 104 down-converts the input reception signal input from the receive antenna 102 into a baseband signal, and then outputs the baseband signal to the A/D unit 106.

The A/D unit 106 converts the input analog signal into a digital signal, and outputs the digital signal to the reception unit 108. The reception unit 108 extracts from the input digital signal, a channel H_{PiPi}, interference source information acquired by the pico cell terminal device i, and receive antenna count information N_{RX(Pi)} of the pico cell terminal device i, and then outputs the channel H_{PiPi} to the transmit filter calculator 110 and outputs the interference source information and the receive antenna count information N_{RX(Pi)} to the higher layer 112. In accordance with Expression (1), the transmit filter calculator 110 calculates a transmit filter W_{TX(Pi)}. In Expression (1), subscript M represents a macro cell, and if the pico cell base station i is used, the subscript Pi is substituted for the subscript M.

The macro cell base station 10 notifies the cooperative cell information to the higher layer 112 via the wired network. The higher layer 112 is thus notified by the reception unit 108 of the interference source information of the pico cell i, and the receive antenna count information N_{RX(Pi)} of the pico cell terminal device i. If the pico cell i is included in the cooperative cells, the higher layer 112 performs a transmission operation (the process of the modulator 114 and subsequent process) in accordance with the cooperative cell information notified by the macro cell base station 10. More specifically, the higher layer 112 of the pico cell base station i performs the operation in step S122 and subsequent operations in FIG. 4.

The operation of the modulator 114 and subsequent operation are identical to those of the macro cell base station 10. The modulator 114 transmits to the terminal device in the host cell the cooperative cell information and the pilot signal in addition to the transmission signal. In the convention of the macro cell base station 10, the subscript M of the transmission data signal s_{M} represents the macro cell. For the pico cell base station i, the corresponding subscript becomes Pi, and the transmission data signal is thus represented by s_{Pi}.

### 1.4 Configuration of Terminal Device

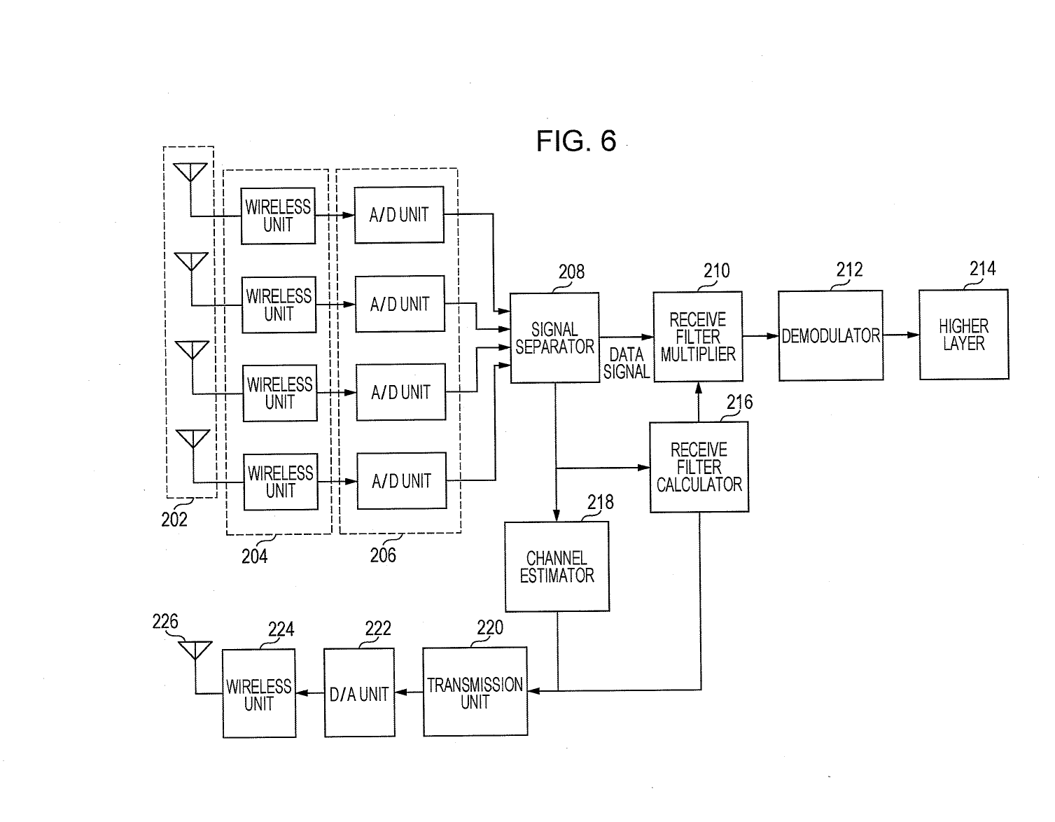

FIG. 6 illustrates the configuration of the terminal device of the present embodiment. The process of the pico cell terminal device 1 (25a) is described below with reference to FIG. 6, and the discussion is also applicable to the macro cell terminal device 15 and other pico cell terminal device.

The terminal device first receives a signal transmitted from an interfering station via a receive antenna 202, and generates interference source information. A wireless unit 204 down-converts the received signal input via the receive antenna 202 into a baseband signal, and then outputs the baseband signal to an A/D unit 206. The A/D unit 206 converts an input analog signal into a digital signal and outputs the digital signal to a signal separator 208.

A signal transmitted by the base station in the macro cell or in another pico cell may reach the pico cell terminal device 1 (25a). This means that these cells interfere with the pico cell terminal 1 (25a). A cell ID of the cell from which the interfering signal has been received is transmitted as the interference source information at the pico cell 1 (5a) to the pico cell base station 1 (20a). The interference source information of the pico cell 1 (5a) includes cell IDs of the pico cells 2, 3, 4, and the macro cell.

The base station of the pico cell 1 (5a) then notifies the macro cell base station 10 of the interference source information via the wired network. In response to the interference source information notified by each pico cell base station, the macro cell base station 10 determines cooperative cells that concurrently transmit streams, and each base station starts transmission in accordance with the cooperative cell information.

Since the pico cell 1 (5a) becomes a cooperative cell at the second frame in the present embodiment, a reception process of the signals at the second frame is described herein. As illustrated in FIG. 5, the cooperative cells include the pico cell 1 (5a), the pico cell 3 (5c), the pico cell 4 (5d), and the macro cell 1.

The terminal device receives the signals transmitted from the base stations. Each base station transmits a signal in accordance with the cooperative cell information. For example, the pico cell terminal device 1 (25a) receives a desired signal from the pico cell base station 1 (20a) and signals from the cooperative cells at the current frame (the pico cell 3 (5c), the pico cell 4 (5d), and the macro cell 1) from among the interfering stations. The wireless unit 204 down-converts the received signals input via the receive antenna 202 into a baseband signal, and the A/D unit 206 converts the input analog signal into the digital signal, and outputs the digital signal to the signal separator 208.

The signal separator 208 separates from the input signal into signals and thus outputs a pilot signal for channel estimation to a channel estimator 218, a pilot signal for equivalent channel estimation and cooperative cell information to a receive filter calculator 216, and data signal to a receive filter multiplier 210.

The receive filter calculator 216 estimates an equivalent channel from the pilot signal for the equivalent channel estimation input from the signal separator 208. Information relating to the equivalent channel between the interfering station and the terminal device is acquired from information transmitted from the interfering station. The pico cell terminal device 1 (25a) acquires equivalent channels H_{P3P1}W_{TX(P3)}, H_{P4P1}W_{TX(P4)}, and H_{MP1}W_{TX(M)} between the interfering stations (the pico cell 3 (5c), the pico cell 4 (5d), and the macro cell 1) and the pico cell terminal device 1 (25a). An equivalent channel H_{P1P1}W_{TX(P1)} between the pico cell base station 1 (20a) and the pico cell terminal device 1 (25a) is acquired from the pilot signal transmitted from the pico cell base station 1 (20a).

The equivalent channel of a cooperative cell at the current frame is extracted from the equivalent channels notified by the interfering stations in accordance with the cooperative cell information notified by the pico cell base station 1 (20a). More specifically, the cooperative cell information indicates that the cooperative cells at the second frame are the pico cell 1 (5a), the pico cell 3 (5c), the pico cell 4 (5d) and the macro cell 1, and H_{P1P1}W_{TX(P1)}, H_{P3P1}W_{TX(P3)}, H_{P4P1}W_{TX(P4)}, and H_{MP1}W_{TX(M)} are thus extracted.

A receive filter W_{RX(P1)} is calculated in accordance with Expression (3) using the extracted equivalent channels, and then output to the receive filter multiplier. Expression (3) is formulated using the extracted channels as elements, and the arrangement order of the elements is not limited to this.

[Math. 3]

W_{RX(P1)}=[H_{P1P1}W_{TX(P1)}H_{P3P1}W_{TX(P3)}H_{P4P1}W_{TX(P4)}H_{MP1}W_{TX(M)}]⁻¹ (3)

The receive filter multiplier 210 multiplies the data signal input from the signal separator 208 by the receive filter W_{RX(P1)} input from the receive filter calculator 216. The receive filter multiplier 210 then extracts a first row of the multiplication result (the vector of 4 rows and 1 column), and set the extracted first row to be a desired signal s_{P1} addressed to the pico cell terminal device 1 (25a).

The first row of the multiplication result is extracted herein. In the extraction from the receive filter W_{RX(P1)} in Expression (3), the elements of the equivalent channel related to the desired signal needs to match those in the multiplication result. More specifically, since the equivalent channel of the pico cell 1 (3a) is elements at a first column in Expression (3), the first row of the multiplication result corresponds to the desired signal.

The demodulator 212 demodulates the desired signal s_{P1} input from the receive filter multiplier 210, and then outputs the demodulated signal to the higher layer 214.

The channel estimator 218 performs a channel estimation process using the pilot signal for the channel estimation transmitted from the pico cell base station 1 (20a). In response to the known pilot signal generated by the pilot signal generator 118 of FIG. 2, the channel estimator 218 estimates the channel H_{P1P1} from the pico cell base station 1 (20a) to the pico cell terminal device 1 (25a) and outputs the channel H_{P1P1} to a transmission unit 220.

The transmission unit 220 converts the channel H_{P1P1}, the receive antenna count information N_{RX(P1)}, and the interference source information into information in a transmittable form, and the D/A unit 222 converts the resulting digital signal into an analog signal. The analog signal is applied to a wireless unit 224. The wireless unit 224 transmits the signal to the pico cell base station 1 (20a) via a transmit antenna 226.

Through this process, information needed by the pico cell base station 1 (20a) is fed back from the pico cell terminal device 1 (25a). Note, however, that it is simply enough if the receive antenna count information N_{RX(P1)} is transmitted at one time, and it is not necessary to transmit the receive antenna count information N_{RX(P1)} periodically.

The reception process of the pico cell terminal device 1 (25a) (group 1) has been described above. The terminal device of another cell performs the same process. For example, the pico cell terminal device 5 (25e) (group 2) acquires equivalent channels H_{P6P5}W_{TX(P6)}, H_{P7P5}W_{TX(P7)} and H_{MP5}W_{TX(M)} between interfering stations (the pico cell 6 (5f), the pico cell 7 (5g), and the macro cell 1) and the pico cell terminal device 5 (25e) from the pilot signal for the equivalent channel estimation transmitted from the interfering stations.

The pico cell terminal device 5 (25e) acquires H_{P5}W_{TX(P5)} from the pilot signal for the equivalent channel estimation transmitted from the base station in the host cell. By referring to the cooperative cell information, the pico cell terminal device 5 (25e) determines that the cooperative cells are the pico cell 5 (5e), the pico cell 6 (5f) and the pico cell 7 (5g), and thus extracts H_{P5P5}W_{TX(P5)}, H_{P6P5}W_{TX(P6)}, and H_{P7P5}W_{TX(P7)}. In the same procedure as with Expression (3), a receive filter W_{RX(P5)} is calculated from the extracted equivalent channel, and is then multiplexed by the received data.

The interference source information is generated based on the signals that each terminal device has received from a nearby cell. The embodiment is not limited to this method. The interference source information may be generated information exchanged between the base stations. For example, in the LTE (Long Term Evolution) system standardized by 3GPP, a mechanism is adopted in which information called OI (Overload Information) indicating an interference level on each resource block is exchanged between nearby base stations.

Interfering sources are approximately learned on each resource block in accordance with the information, and a resource assignment status and an approximate position relationship of the base station devices, and the interference source information of each resource block is thus generated.

In such a case, the pico cell base station 20 notifies the macro cell base station 10 of OI. Since the macro cell 1 and the pico cell 5 are installed in a planned manner by a communication operator, the interference source information may be set up in accordance with cell installation position relationship during the installation. In such a case, each terminal device is free from generating the interference source information and the process of each terminal device may be facilitated.

Control information such as RNTP (Relative Narrowed Tx Power) exchanged between base stations may be used as the cooperative cell information. Since RNTP is information that indicates transmission power of each resource block in each cell, the macro cell base station 10 can learn the transmission power of each cell by referencing this information.

A cell having lower transmission power may be determined as a cell not included in the cooperative cells and a cell having higher transmission power may be determined as a cooperative cell.

In such a case, the pico cell base station 20 notifies the macro cell base station 10 of the RNTP. If the cell installation position relationship is learned in advance as previously described, the interference source information of each resource block can be generated in view of the position relationship and the RNTP.

Further, if the cell installation position relationship is learned in advance, the number of cells that suffer from interference is learned instead of the cell ID of the interfered cell, and is then notified as the interference source information to the macro cell base station 10.

This is because which cell affects which cell may be predicted by referring to the approximate position relationship and the number of interfering cells. Such a prediction may be considered possible from the cell position relationship alone. However, an inactive cell can be present, and if such an inactive cell is included in the cooperative cells, transmission efficiency is greatly lowered. Such an inconvenience may be overcome by notifying the macro cell base station of the number of interfered cells at an appropriate timing.

In accordance with the present embodiment, information needed to determine the combination of cells that transmit streams to the macro cell base station 10 is collected, and the cells that concurrently transmit streams are thus determined. The base station that performs such a control process is not limited to the macro cell base station 10. Alternatively, a central control station other than the macro cell may be installed.

The present embodiment has been discussed on the example in which the macro cell becomes an interference source to all the pico cells. The present invention is not limited to the example. Even if a pico cell almost free from interference from the macro cell is present, the method of determining the cooperative cells is still applicable.

In the example, the transmission is suspended on any one cell only. The present invention is not limited to this example. A plurality of cells may suspend transmission depending on the relationship between the degree of freedom of each terminal device and the number of cells near the terminal device.

The present embodiment relates to the method that adjusts the number of streams of the mutually interfering cell group so that interfering signals are allowed within a range that does not exceed the degree of freedom of each terminal device. The method does not necessarily suspend all the transmission from the cell.

In other words, each cell transmits a plurality of streams, and interfering signals exceeding the degree of freedom of a terminal device may come in. For example, if the reduction of the stream count of each cell by one can avoid such an inconvenience, the suspension of all the transmission in any one cell becomes unnecessary.

The present embodiment has been discussed on the example in which the cooperative cell information is attached to the data signal before being transmitted. The cooperative cell information relates to scheduling indicating the resource assignment. The cooperative cell information may thus be notified to each terminal device via a control channel or the like. In this case, the cooperative cell information may partly duplicate scheduling information. Furthermore, duplicate information may be deleted for efficient transmission. This may be interpreted to mean that part of scheduling to be performed by the pico cell is shouldered by the macro cell.

In accordance with the present embodiment, each terminal device can determine which cell is a cooperative cell in accordance with the cooperative cell information. The present invention is not limited to this method. Each terminal device can simply acquire information as to whether the host cell is a cooperative cell and information that indicates the location of the pilot signal transmitted from the host cell. Even if each terminal device is unable to identify which of the other cells is a cooperative cell, the terminal device can still estimate the channel in accordance with the pilot signal. Upon learning the location of the pilot signal of the host cell, the terminal device can demodulate the desired signal.

### 2. Second Embodiment

A second embodiment of the present invention is described below. In accordance with the first embodiment, the higher layer 112 of the macro cell base station 10 determines the cell combination so that the number of cells that concurrently transmit signals is equal to or below the degree of freedom of the terminal device, and so that the cell combination is alternated every frame. A method of ensuring reception quality at the terminal device in the cell combination determination is described below.

The configuration of a communication system of the present embodiment is identical to that of the first embodiment (FIG. 1). The configurations of the base station and the terminal device in each cell are identical to those illustrated in FIG. 2 and FIG. 6.

A difference from the first embodiment is that a terminal device at each cell measures reception quality, and feeds back the measured reception quality to the base station. In order for the macro cell base station 10 to acquire the reception quality of the terminal device in another cell, each pico cell base station 20 notifies the macro cell base station 10 of the reception quality of the terminal device via the wired network. The macro cell base station 10 determines a combination of cooperative cells in accordance with the reception quality notified by each cell and the reception quality notified by the macro cell terminal device 15. The process different from that of the first embodiment is described below.

Each terminal device measures an incoming signal from the connected base station and reception power of an incoming signal from a nearby cell by referencing the pilot signal for the channel estimation, calculates SINR (Signal to Interference plus Noise Power Ratio), and sets SIRN to be the reception quality. The transmission unit 220 further converts the calculated reception quality in addition to the channel, the receive antenna count information, and the interference source information into information in a transmittable form, and then transmits the information to the base station in the host cell via the transmit antenna 226.

The pico cell base station 20 notifies the reception quality notified by each pico cell terminal device 25 to the macro cell base station 10 via the wired network. In this way, the reception quality of each terminal device in each cell is notified to the macro cell base station 10.

The process of the macro cell base station 10 is described next. The higher layer 112 of FIG. 2 is notified of the reception quality of each terminal device. The process flow of the higher layer 112 of the present embodiment remains unchanged from that of the first embodiment (FIG. 4) except for the process content in step S114 of FIG. 4 in the first embodiment.

In step S114, in accordance with the present embodiment, the cell combination that concurrently transmits signals are set to be the cooperative cell information by referencing the reception quality of each terminal device. More specifically, from among the group 1 (the pico cell 1 (5a) through the pico cell 4 (5d) and the macro cell 1), a combination of cells, each having a high reception quality, is set to be cells that concurrently transmit signals. If the terminal devices have the reception qualities of the pico cell 1 (5a)>the pico cell 2 (5b)>the pico cell 3 (5c)>the macro cell 1>the pico cell 4 (5d) in the order from high to low reception quality, the pico cell 4 (5d) is set to be a cell that is to be suspended, and the four cells other than the pico cell 4 (5d) are set to be the cooperative cells. In accordance with the present embodiment in this way, the combination of cells that are permitted to concurrently transmit signals in the order from high to low reception quality of the terminal devices.

If the cells that are to concurrently transmit signals are selected in accordance with the reception quality in this way, a state that cells having a low reception quality are not to transmit signals is prolonged. In addition to the process, a combination of cells to concurrently transmit signals may be determined in view of an amount of data transmitted heretofore. For example, in step S120 of FIG. 4, the cooperative cell information of the past is stored, and if a given cell is continuously suspended, that cell is disengaged from a suspended state, and a cell is then selected from among the remaining cells in the order from low to high reception quality.

### 3. Third Embodiment

A third embodiment of the present invention is described below. In accordance with the first and second embodiments, the cells of concurrent transmission are selected based on the antenna count information, the stream count information, and the reception quality on the assumption that the stream count to be transmitted (the stream count information) is determined in advance. Described below is a method of the macro base station that determines the stream counts of cells of concurrent transmission so that a terminal device having a higher reception quality transmits more streams in accordance with the reception qualities of the terminal devices.

The configuration of the communication system of the present embodiment is identical to that illustrated in FIG. 1, and the configurations of the base station and terminal device in each cell are identical to those illustrated in FIG. 2 and FIG. 6. The present embodiment is different from the other embodiments in that the higher layer of the macro cell base station 10 determines the stream count of each cell and that each cell performs a transmission operation in accordance with the determined stream count. In accordance with the present embodiment, the stream count information determined by the macro cell base station is notified to the pico cell base station via the wired network.

The process content of the higher layer 112 of the present embodiment is identical to that of FIG. 4 but the present embodiment is different from the second embodiment in the operation in step S114 of FIG. 4. The number of cooperative cells and the number of streams are determined in view of the reception quality so that the cooperative cell count increases as many as possible in step S114 of the second embodiment. The present embodiment is different from the second embodiment in that more streams are assigned to a cell having a higher reception quality, and that the number of cooperative cells is decreased accordingly.

In step S114, in accordance with a threshold value of the reception quality, the stream count is set so that a terminal device having a reception quality higher than the threshold value has a higher number of streams. The reception qualities may be set to be the pico cell 1 (5a)>the set threshold value>the pico cell 2 (5b)>the pico cell 3 (5c)>the macro cell 1>the pico cell 4 (5d) in the order from high to low reception quality. The pico cell having a reception quality higher than the set threshold value (the pico cell 1 (5a)) is determined as being a cell that is to be increased in stream count. Although the current pico cell 1 (5a) as the cell to be increased in stream count currently has R_{P1}=1, the stream count is newly set to be R_{P1}=2. However, the newly set stream count needs to be not more than the minimum receive antenna count x of the group. In the present embodiment, the upper limit value of the newly set stream count is 4, and thus relationship 2≦R_{P1}≦4 holds.

The stream count of another cell is determined so that the relationship of the total sum of streams transmitted from within the group≦the minimum receive antenna count x within the cooperative cells holds. For example, if the stream count is set as R_{P1}=2, R_{P2}=R_{P3}=1, R_{M}=R_{P4}=0, the stream count R_{P1} of the pico cell 1 (5a) having a reception quality higher than the set threshold value is increased while the stream count constraint is satisfied because R_{P1}+R_{P2}+R_{P3}+R_{M}+R_{P4}=2+1+1+0+0=4. Therefore, the cooperative cells in the group 1 are the pico cell 1 (5a), the pico cell 2 (5b) and the pico cell 3 (5c). Unlike the second embodiment, the present embodiment permits a cell having a higher reception quality to be assigned more streams by changing the cooperative cell count and the stream count in accordance with the reception quality.

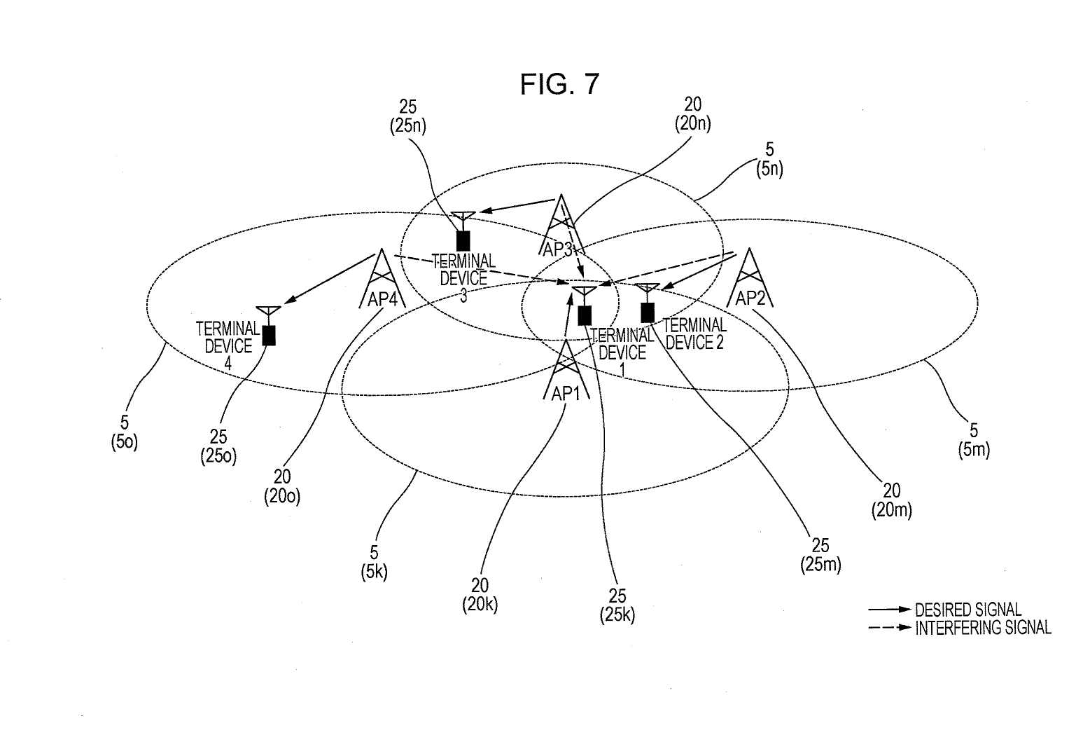

Furthermore, the present invention is also applicable to a wireless communication system or the like where communication coverage areas overlap each other as illustrated in FIG. 7. FIG. 7 illustrates a wireless LAN (Local Area Network), in which AP (Access Point) 1 (20k) transmits a desired signal to a terminal device 1 (25k), AP 2 (20m) transmits a desired signal to a terminal device 2 (25m), AP 3 (20n) transmits a desired signal to a terminal device 3 (25n), and AP 4 (20o) transmits a desired signal to a terminal device 4 (25o).

An ellipse centered on each AP represents a service areas 5 (5k, 5m, 5n, and 5o), and a desired signal transmitted from each AP becomes an interfering signal to another terminal within the area.

As illustrated in FIG. 7, interfering signals to the terminal device 1 only are represented by arrows. The terminal device 1 (25k) receives the desired signal from AP 1 (20k), and interfering signals from AP 2 (20m), AP 3 (20n), and AP 4 (20o).

Furthermore, the terminal device 2 (25m) receives a desired signal from AP 2 (20m), and interfering signals from AP 1 (20k) and AP 3 (20n). The terminal device 3 (25n) receives a desired signal from AP 3 (20n) and an interfering signal from AP 4 (20o). The terminal device 4 (25o) receives a desired signal from AP 4 (20o).

If the receive antenna count of all the pico cell terminal devices 25 is two and the stream count of the desired signal is one, then the interference count removable is one. Since the terminal device 1 (25k) and the terminal device 2 (25m) lack the degree of freedom, the desired signal cannot be extracted if the incoming signal is multiplied by the linear receive filter.

In such a case, as described with reference to the embodiments, the stream count of the mutually interfering AP group is adjusted so that interfering signals not exceeding the degree of freedom of each terminal device are permitted. Each terminal device can remove interference and extract a desired signal.

In the above embodiments, the macro base station (central control station) determines the cooperative cell information. Since no central control station is present in the system of FIG. 7, AP that determines the cooperative cell information needs to be decided.

As illustrated in FIG. 7, the AP is the one to which a terminal device having received most interfering signals from other APs belongs, and AP 1 (20k) thus becomes the central control station. Alternatively, the AP may be the one to which a terminal device having the smallest number of receive antennas belongs.

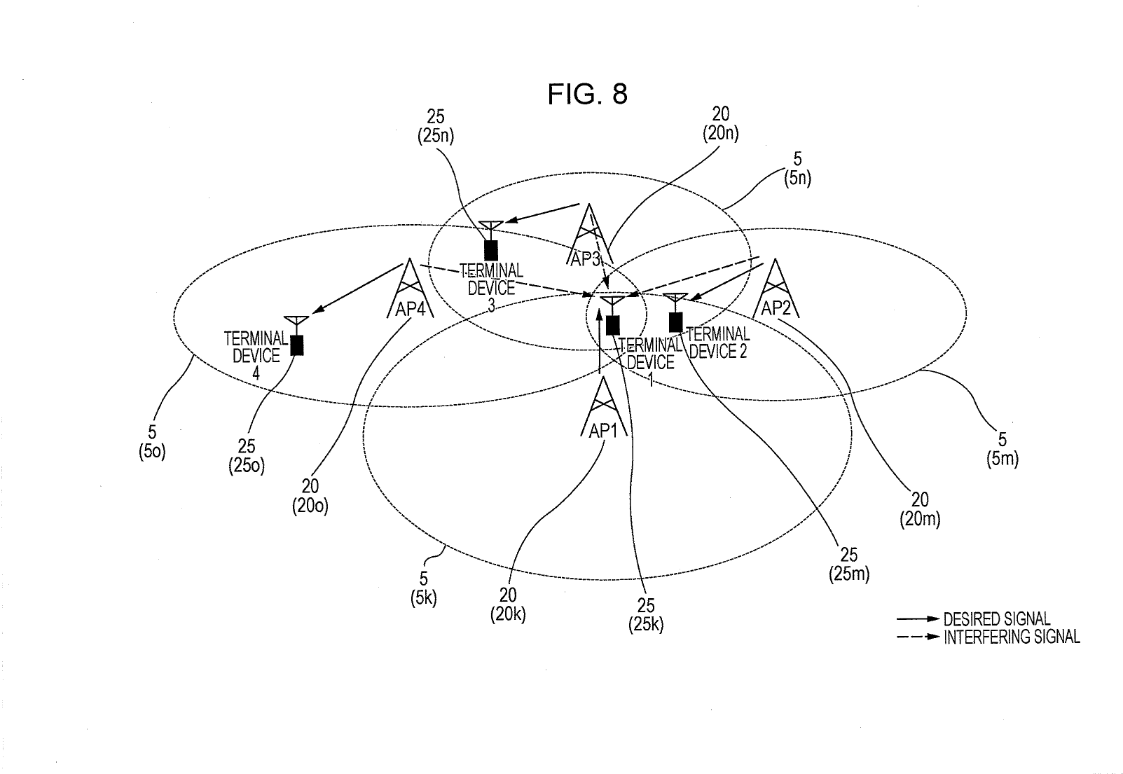

FIG. 8 illustrates a version of the wireless LAN system of FIG. 7 in which the size (range) of each service area is different. In this case as well, the present invention is applicable.

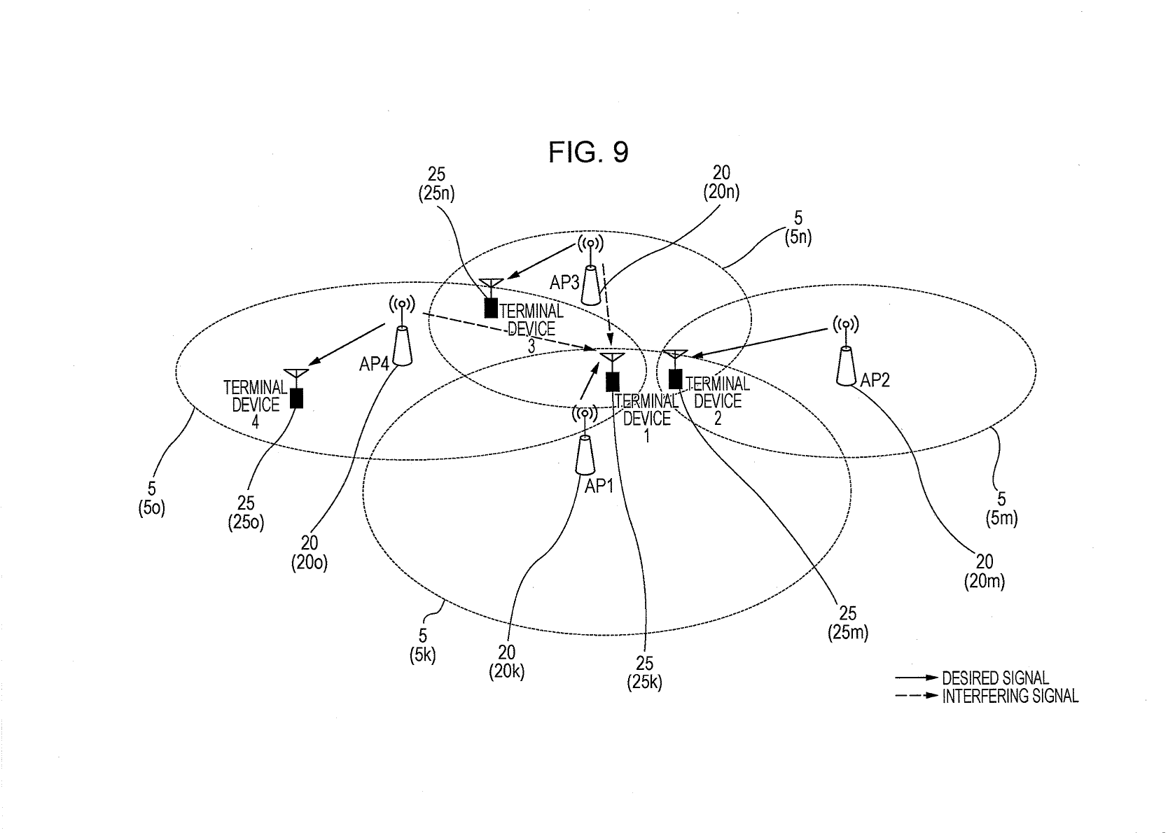

In the wireless LAN systems of FIG. 7 and FIG. 8, all the service areas overlap each other. FIG. 9 illustrates service areas, some of which do not overlap each other, more specifically, a service area 2 does not overlap a service area 4.

In such a case, the number of interfering signals arriving at the terminal devices is two to the terminal device 1 (25k), two to terminal device 2 (25m), one to the terminal device 3 (25n), and 0 to the terminal device 4 (25o). The terminal device 1 (25k) and the terminal device 2 (25m) lack the degree of freedom. In the same manner described with reference to the previous embodiments, the stream count of the AP group mutually interfering with each other is adjusted so that the interfering signals not exceeding the degree of freedom of each terminal device come in.

A method of determining the central control station in this case may be the same as the method used in FIG. 7. For example, the AP is the one to which a terminal device having received most interfering signals from other APs belongs. More specifically, AP 1 (20k) or AP 2 (20m) may be the central control station. Alternatively, the AP may be the one to which a terminal device having the smallest number of receive antennas belongs, or may be the one that has the largest number of overlapping areas. AP 1 (20k) may be selected as the central control station by accounting for the plurality of these conditions, for example accounting for the condition of the number of overlapping service areas in addition to the condition of receiving the largest number of interfering signals (satisfied by AP 1 (20k) or AP 2 (20m)).

The configuration described above is effective not only to the wireless LAN system but also to a system where a large number of transceivers are present in a relatively narrow area. For example, the configuration is applicable to a home system where a variety of home electric appliances are mutually connected via a wireless network.

### REFERENCE SIGNS LIST

1 Macro cell
10 Macro cell base station
102 Receive antenna
104 Wireless unit
106 A/D unit
108 Reception unit
110 Transmit filter calculator
112 Higher layer
114 Modulator
116 Transmit filter multiplier
118 Pilot signal generator
120 D/A unit
122 Wireless unit
124 Transmit antenna
15 Macro cell terminal device
3, 3a, and 3b Pico cell groups
5, 5a through 5g Pico cells
20, 20a through 20g Pico cell base stations
25, 25a through 25g Pico cell terminal devices
202 Receive antenna
204 Wireless unit
206 A/D unit
208 Signal separator
210 Receive filter multiplier
212 Demodulator
214 Higher layer
216 Receive filter calculator
218 Channel estimator
220 Transmission unit
222 D/A unit
224 Wireless unit
226 Transmit antenna

1. A control station device configured to perform communications controlled by a central control station device,
wherein the control station device acquires information related to a control station device that becomes an interference source to a coverage area controlled by the control station device,
notifies the central control station device of the information related to the control station device that becomes the interference source, and
acquires, from the central control station device, information related to a possibility of communications thereof.

2. The control station device according to claim 1, wherein the information related to the control station device becoming the interference source identifies the number of control station devices becoming the interference sources or the control station devices becoming the interference sources.

3. The control station device according to claim 2, wherein the control station device acquires information related to a receiving performance of a terminal device that serves as a communication partner of the control station device, and notifies the central control station device of the information related to the control station device that becomes the interference source and the information related to the receiving performance.

4. A central control station device configured to control communications of a control station device,
wherein the central control station device acquires, from the control station device, information related to a control station device becoming an interference source to a coverage area controlled by the control station device, and
determines possibility of communications in each of the coverage area controlled by the central control station device and the control station device in accordance with the acquired information, the number of receive antennas of a terminal device that serves as a communication partner of the central control station device and the control station device, and the number of streams in each cell.

5. The central control station device according to claim 4, wherein the central control station device acquires information related to a receiving performance of a terminal device that serves as a communication partner of the control station device, and information related to a receiving performance of a terminal device that serves as a communication partner of the central control station device, and
determines the number of streams in the cell controlled by the control station device in accordance with the acquired information, and notifies the control station device of the pieces of information.

6. A terminal device configured to be connected to a control station device performing communications controlled by a central control station device, wherein the terminal device notifies information of a receiving performance thereof and information related to a control station device that becomes an interference source to the central control station device via the control station device.

7-8. (canceled)
